(19) United States
(12) Patent Application Publication
(10) Pub. No.: US 2006/0013229 A1
(43) Pub. Date: Jan. 19, 2006

(54) Method and arrangement to reserve resources in an ip network

(76) Inventors: Joachim Johansson, Docentvagen (SE); Joakim Norrgard, Sandviksatan (SE)

Correspondence Address: YOUNG & THOMPSON, 745 SOUTH 23RD STREET, 2ND FLOOR, ARLINGTON, VA, 22202, US

(21) Appl. No.: 10/533,451

(22) PCT Filed: Oct. 22, 2003
(86) PCT No.: PCT/SE03/01636

§ 371 Date: May 2, 2005

(30) Foreign Application Priority Data
Oct. 30, 2002 (SE) 0203189-6

(51) Int. Cl. H04L 12/56

(52) U.S. Cl. 370/395.41

(57) ABSTRACT

The invention relates to a method for pre-allocating network resources within an IP-network. Reserved resources are allocated based on usage history statistics when available usage history statistics is applicable to the resource reservation request. Network resources are allocated individually for said requested resource reservation when applicable usage history statistics is not available, and the usage history statistics is updated based upon the result of said individually allocated resources. The invention relates also to resource manager where said method is implemented and a computer program product that performs the steps of the method according to the present invention.

### FIELD OF INVENTION

The present invention relates to a resource manager in an Internet Protocol (IP) network and a method for allocating network resources in an IP network and a computer program product for performing the steps of said method.

In particular, the invention relates to a method for allocating network resources in advance in the IP network, and a resource manager and a computer program product for performing the steps of said method.

### BACKGROUND OF THE INVENTION

A current networking trend is to provide “IP all the way” to wired and wireless units. Some current objectives are to simplify the network infrastructure, to support a wide range of applications, and to support diverse user demands on the communication service. To allow this, there is a need for scalable solutions supporting service differentiation and dynamic resource management in IP networks.

The primary goal when the Internet Protocols were designed was to provide an effective technique for interconnecting existing networks. One design trade-off made to enable the interconnection was to support only best-effort service at the network level and rely on endpoint functionality to obtain various levels of service. Best-effort service provides adequate support for traditional data applications that can tolerate delay, loss and varying throughput along the path. However, in networks carrying high loads of traffic, this type of service is often inadequate for meeting the demands of applications that are more sensitive to packet loss and delay e.g. telephony, video on demand, multimedia conferencing, etc. These types of applications require a more reliable resource allocation than what best-effort can offer.

Consequently, there are strong commercial reasons for network operators and equipment providers to offer Quality-of-Service (QoS) differentiation in IP networks. I.e., the users within a network are divided into different group depending on their priority, e.g. high prioritized users are offered more available resources than users with lower priorities.

RSVP (Resource Reservation Protocol) is a signalling protocol standardised to set up per-flow quality of service in routers supporting IntServ (Integrated Services defined in Braden et Al, Integrated Services in the Internet Architecture: an Overview, IETF, RFC1633) along the path. In the RSVP all resource requests are signalled end to end, which results in a huge amount of signalling.

The scalability problems of per-flow QoS management in routers have resulted in the differentiated services architecture defined in Blake et Al, An architecture for Differentiated Services, IETF, RFC2475. The objective is to provide scalable QoS support by avoiding per-flow state in routers. The basic idea is that IP packet headers include a small label (known as the diffserv field) that identifies the treatment per-hop behaviour that packets should be given by the routers. The standard model is, however, limited to differentiated forwarding in routers and therefore the challenge lies in providing predictable services to end users.

The entity performing dynamic admission control is here called a resource manager and is further described in Wolf, L. C., Delgrossi, L., Steinmetz, R., Schaller, S., Wittig, H., “Issues of Reserving Resources in Advance”, IBM European Network Center Heidelberg, TR 43.9503, 1995. The resource manager keeps track of the available transmission resources, e.g. bandwidth, and performs admission control on incoming requests for resources from clients. The resource manager manages the resources within one domain. To perform the admission control the resource manager also stores a history of previously admitted resource reservations. The resource manager takes decisions to admit new requests for resources based on the total amount of available resources, the amount currently reserved by previously reservations and the amount of resources requested. The resources may or may not be scheduled over time. One request may involve admission control on multiple resource repositories that may consist of different types of resources. The most common type of resource managed is bandwidth.

There are specific requirements for resource management mechanisms. To provide service to end users, they must be aware of network resources and may schedule them for the committed service at any granularity (e.g. for a port range, for aggregate traffic between a pair of subnets, etc).

The mechanisms should provide accurate resource control both in leaf domains and in core domains. In leaf domains there may be requirements for very fine granular resource control (e.g. per application data stream), especially at licensed band wireless access where bandwidth is so expensive that spectrum efficiency is the overall goal. The performance must also be sufficient to handle mobility and frequent hand-over. In core domains, dynamic aggregated resource management (e.g. per destination domain, per port range for IP telephony, etc.) may be provided for scalability reasons. ISPs need support for negotiating bulk bandwidth with each other by using reservations in advance and time-dependent contracts (e.g. time of day, day of week, etc.). In enterprise networks, there are often well-provisioned LANs and bottleneck leased lines to interconnect sites. They need support for deploying new internal services (e.g. multimedia conferencing) that require certain amounts of resources, and these applications must be controlled to avoid excessive negative impact on other traffic.

In the international patent application PCT/SE02/00618 filed on Mar. 28, 2002, it is disclosed how a resource manager handles a mixture of immediate open-ended requests (the duration of a session is unknown when resources are requested) and requests of pre-allocations of resources.

To increase statistical gain of pre-allocation, multiple destinations may be aggregated to a larger destination prefix and the funnel concept that was introduced in Olov Schelén, Quality of Service Agents in the Internet, Doctoral Thesis, Department of Computer Science and Electrical Engineering, Division of Computer Communication, Luleå University of Technology, Luleå, 1998, may be adopted.

The idea with the funnel model is that resource managers can ask for resources from other resource managers. Reservations from different sources to the same destination are aggregated where they merge along the paths so each resource manager has at most one reservation per destination domain with their neighbouring peers. A further improvement of the funnel concept is described in the Swedish patent application 0102929-7 filed on Sep. 4, 2001.

### State of the Art

There are currently very few known specifications and implementations of resource managers and even fewer handles reservations involving multiple resource managers, referred to as inter-domain reservations if the involved resource managers manage resources belonging to different domains. The funnel concept described above describes a method with over-allocation of resources in each inter-domain hop and does not describe any method to pre-allocate resources based on usage statistics.

In P. Pan, E, Hahne, and H. Schulzrinne, “BGRP: A Tree-Based Aggregation Protocol for Inter-domain Reservations”, Journal of Communications and Networks, Vol. 2, No. 2, June 2000, pp. 157-167, a protocol called Border Gateway Resource Protocol (BGRP) is developed to cope with the inter-domain scalability problems with RSVP in the terms of state and signalling. They aggregate reservations with the same destination in the border router (a router located close to the domain border) in the source domain. To further lessen the signalling they propose two extensions:
Over-reservation, Quantization and Hysteresis
Quiet Grafting and CIDR Labeling

In over-reservation the source leaf domain over-allocates resources so it does not have to signal for each individual request in the domain. Quiet Grafting means that it is one of the intermediate routers that over-allocates resources to a “popular” destination. Problems with these extensions will be discussed below.

The QBone Signaling workgroup has begun to specify a protocol for inter-domain QoS signalling called SIBBS. These concepts do not involve pre-allocation of resources to destinations but instead rely on signalling each reservation request hop by hop. In Ibrahim Khalil, Torsten Braun, “Implementation of a Bandwidth Broker for Dynamic End-to-End Resource Reservation in Outsourced Virtual Private Networks”, University of Berne, Switzerland, end-to-end admission control is discussed but algorithms for pre-allocation of resources to other domains are not presented. In V. Sander et al, “End-to-End Provision of Policy Information for Network QoS”, The University of Chicago, Chicago, inter-domain reservations and signalling between different resource managers are discussed and two models of signalling is primarily discussed. Pre-allocation of resources in order to reduce signalling is however not considered.

The most common type of pre-allocation is a manually configured static amount of resources between adjacent resource managers. This is often part of a service level agreement between the two neighbouring resource managers.

Over-allocation and aggregation of many reservations into one solves performance and scaling problems as admission decisions are localised. The alternative, involving multiple resource managers for each admission decision, reduces performance, increases the delay and may also introduce state per reservation in all involved resource managers.

One problem with all methods using over-allocation of resources hop by hop is that reservations spanning many resource manager hops are over-allocated for each hop and thus the over-allocation will increase for each hop. If for example an over-allocation algorithm is used that reserves twice as much as the desired amount the total amount reserved along the path will increase exponentially with the number of hops i.e. already over-allocated requests are over-allocated again and again. FIG. 2 illustrates a first domain 200 comprising a client and a second domain 204 comprising a resource manager RM4. The client requests resources to the second domain 204 via resource managers RM1, RM2 and RM3 located in respective intermediate domains 201, 202, 203. Thus, FIG. 2 illustrates that over-reservations increase exponentially with the number of hops.

In addition, signalling over many hops may lead to long response delays for the client.

Network usage is often periodic to time-of-day, day-of-week and so on according to S. Uhlig, 0. Bonaventure, “IST Project ATRIUM Report I4.2—Analysis of Interdomain Traffic”, Technical Report, 2001, especially if the clients have some geographic locality. The typical usage for a service may for example look similar to the usage shown in the graph in FIG. 3. To manually allocate a static amount of resources to cover the usage in FIG. 3, a level equal to the peak usage must be allocated. Actually, in this case, to be sure that variations and sporadic peaks in usage are covered by a static level, more resources must be allocated. Notice that in the periods of lower usage (e.g. during the night in this example), such static over-allocation would lead to a large amount of unused resources, i.e. low utilisation.

One way of increasing the utilisation is to manually modify the “static” level of allocated resources each hour but this would be very time consuming. Modifying the level at the time resources are needed could also be done automatically but is however hazardous since there is no guarantee that the needed resources are available. It would thus be favourable to be able to pre-allocate resources in advance. In this example the whole day with different levels for different hours would preferably be pre-allocated in-advance based on previous usage history, if such usage history is available.

FIG. 4 shows an example with usage history for one day back to the left and currently reserved resources to the right. In this example there is a large amount of short-term immediate reservations, e.g. from IP-telephony applications, and also some reservations made in advance, e.g. for multipart conferences. Assuming that the immediate reservations can be quite short (about minutes) it would be hard to predict the required resources in advance just by looking at the current reservations (to the right in the figure).

Only by looking backwards in time it is possible to find out how many resources that were actually reserved for each hour. Thus, usage history is important in order to be able to allocate resources in advance. Even if there is a large amount of in-advance reservations it would be hard to predict the required resources since clients tend to reserve more in the near future than far in the future.

In the example in FIG. 4 the resources needed for the upcoming day could be pre-allocated based on the usage history of previous days as depicted in FIG. 5. The arrows in FIG. 5 indicate where resource needs are predicted based on usage history. In this example the pre-allocated resources for each hour are based on the usage history of corresponding hours in previous days. This kind of pre-allocation only based on history gives better utilisation than static allocation but it does not handle sporadic peak usage and variations in usage patterns very well, since the usage history cannot be adapted to a changed usage pattern. E.g. if a client requests a resource reservation not corresponding to the available usage history statistics, the request will not be admitted and no update of the available statistics is performed unless the statistics is based on requests. Another example is when there is no usage history statistics available in the beginning. Hence, no resources can be allocated based on previous usage statistics, which implies that the only possible available usage statistics is based on requests. However, the usage history, that is not based on actually admitted and used resources but only on requested resources is often misleading since a client may have made many requests for the same resource until it was admitted by the resource manager.

EP 1035666 A2 discloses an apparatus for reserving resources. The apparatus monitors an active session and adjusts the reservation based on predicted changes in the near future. A drawback with EP 1035666 is that it is not able to reserve resources in advance, i.e. before the session has started, e.g. one day ahead between 7-8 pm.

Thus, an object with the present invention is to provide a resource manager and a method thereof that allocates network resources in advance automatically adapted to varying usage patterns with minimal signalling and still producing a high utilisation.

### SUMMARY

The above-mentioned object is achieved by a resource manager, a method, and a computer program product set forth in the characterizing part of the independent claims.

Preferred embodiments are set forth in the depending claims.

An advantage with the present invention is that it makes it possible to reserve resources in advance by using algorithm 1, i.e. before the session it reserves resources for, has started. Furthermore, it is possible to reserve resources intended for sessions e.g. one day ahead between e.g. 7-8 pm. The selected amount of resources reserved is based on usage statistics for that time period. Thus, a major part of all resource reservations may be handled this way. However, there exist other situations when changes in the network usage occurs, e.g. sporadic peak usage. Therefore, the algorithm 2 is introduced that can handle such changes. Thus, the algorithms 1 and 2 work in parallel simultaneously, wherein algorithm 1 is based on usage history and algorithm 2 is based on the current resource requirement and on the resource requirement in a near future.

Another advantage with the present invention is that the combined algorithms 1 and 2 according to the present invention reduce the end-to-end signalling between resource managers and thus increase the speed of the admission control by taking local decisions. This will also reduce the average delay from request to reply for the client. In normal operation many thousands of inter-domain reservation requests may be aggregated into a single inter-domain pre-allocated resource. This will also reduce the state that needs to be stored in the other resource managers along the path.

A further advantage with the present invention is that the solution also increases the utilisation by adapting to any periodicity of the usage patterns and increases the availability of the service by pre-allocating the resources in-advance so that resources are available at the time they are needed.

### BRIEF DESCRIPTION OF THE DRAWINGS

FIG. 1 illustrates an IP network schematically, wherein the present invention may be implemented.

FIG. 2 illustrates schematically over-allocation at each hop in a network.

FIG. 3 is a graph showing a typical time-of-day usage pattern.

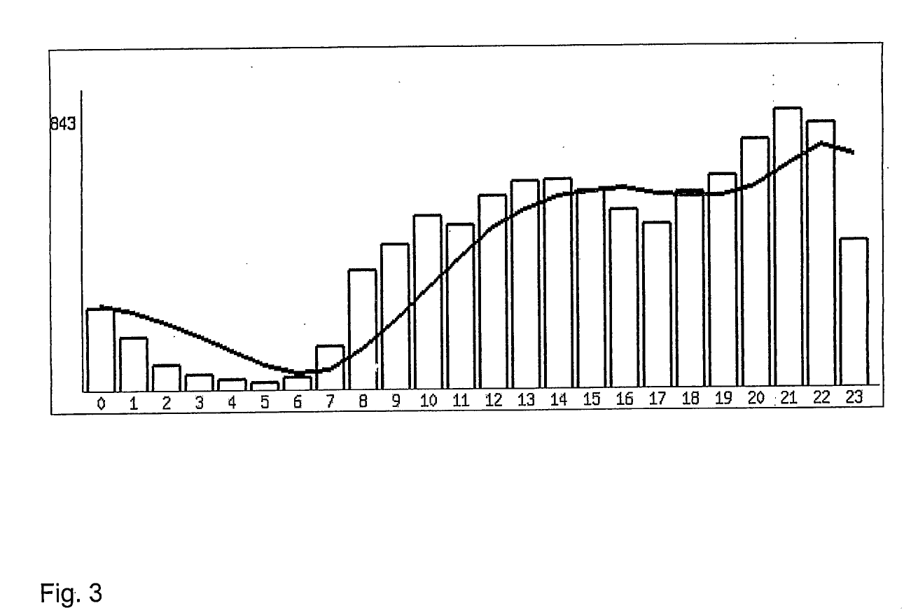

FIG. 4 is a graph showing Usage history to the left and currently reserved resources to the right

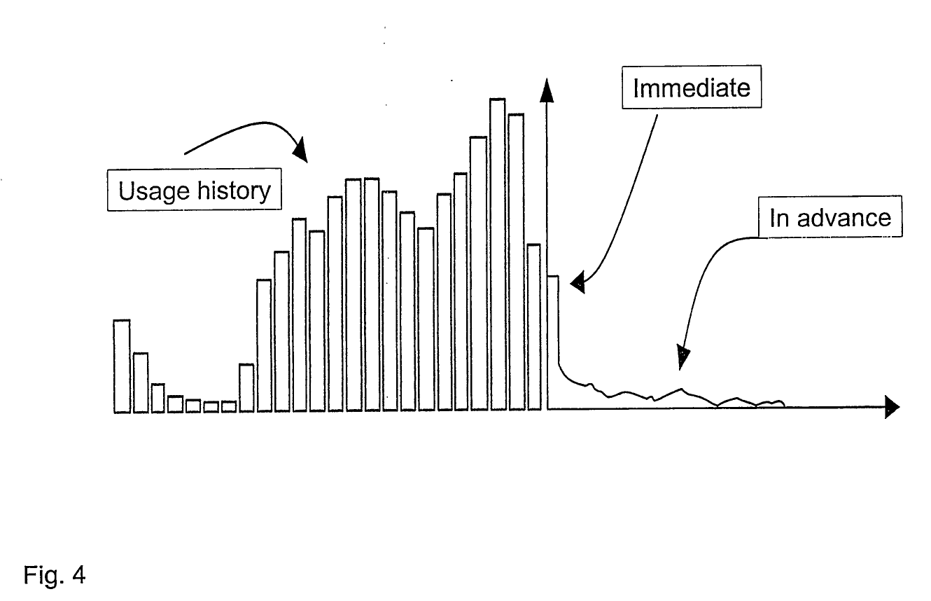

FIG. 5 is a graph showing pre-allocation one day of resources based on previous usage history.

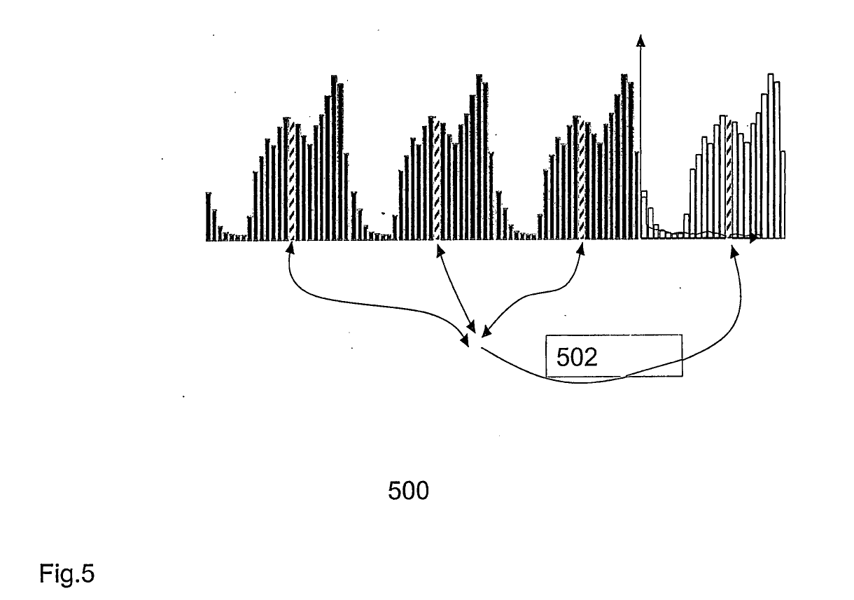

FIG. 6 is a graph showing the amount of resources allocated by the two algorithms in accordance with the present invention.

FIG. 7 is a block diagram showing a resource manager according to the present invention.

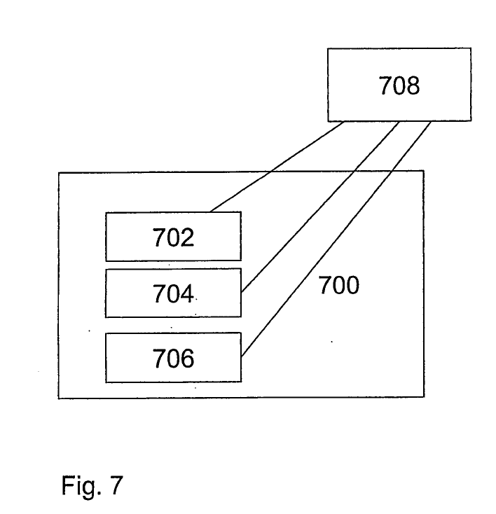

FIG. 8 is a flowchart of the method in accordane with the present invention.

### DETAILED DESCRIPTION OF PREFERRED EMBODIMENTS

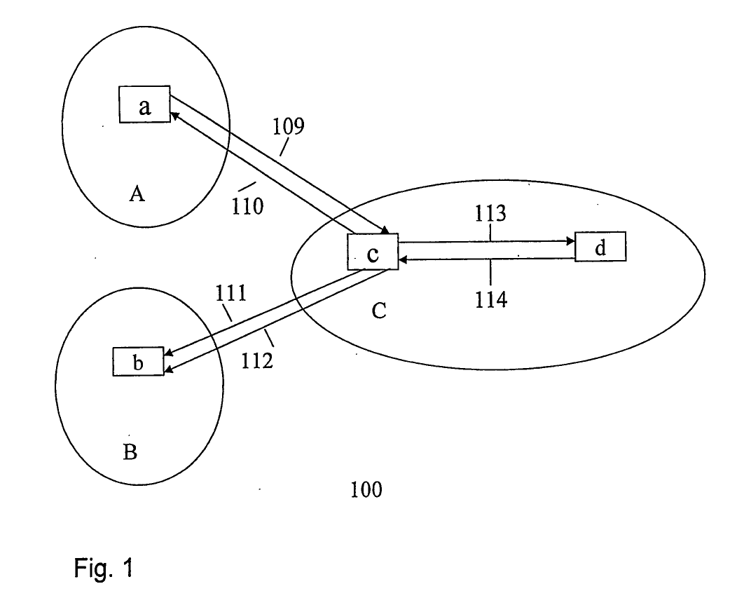

FIG. 1 illustrates an IP network 100 where the present invention may be implemented. The network 100 comprises at least one network domain A;B;C, at least two resource managers a;b;c;d, wherein said resource managers a;b;c;d are located within the same network domain or in different network domains. Each network domain may comprise a plurality of routers, endpoints (e.g. pc, IP telephones etc.) and servers connected to each other (not shown in FIG. 1). However, each domain comprises at least one resource manager a;b;c;d that is implemented within one of the plurality of servers or routers. The resource managers are adapted to communicate 109-114 with each other.

A solution to the problem of pre-allocating resources that automatically adapts to varying usage patterns with minimal signalling and still producing a high utilisation is in accordance to the present invention to combine a first algorithm and a second algorithm that work in parallel. The algorithms are used by a first resource manager, which receives a resource reservation request from a client, or a second resource manager, and requests resources further from a third resource manager. It is also possible that the first resource manager requires the requested resources itself. Thus, the first resource manager allocates resources to the requesting entity, i.e. to the client, the second resource manager or the first resource manager itself, if the requested resources are admitted.

Briefly, the first algorithm is looking backwards in time and the second algorithm is looking forward. I.e., the first algorithm, algorithm 1, uses history statistics of resource usage. This statistics describes when and how many resource requests that actually have been admitted and reserved and further predicts the upcoming needs and pre-allocates the predicted resource needs in advance. The first algorithm is used to reserve resources in advance before the session, that will use said resource, has started.

The second algorithm, algorithm 2, allocates network resources individually for each resource reservation where the available usage history statistics is not possible to use, and thus does not fit into the pre-allocated resources allocated by algorithm 1. In addition, the algorithm 2 updates said usage history statistics used in algorithm 1 based on the individually allocated resources.

If there are no previous usage statistics available, either because a previously unused destination is beginning to be used or if the system is started without any usage history, algorithm 1 will not pre-allocate any resources and algorithm 2 will thus have to signal individually for each reservation request received. However, the results from the resource allocations by algorithm 2 are collected for the usage history statistics for algorithm 1. In time, the amount of usage statistics will be increased so that algorithm 1 will start to pre-allocate resources to the destination in use. (A destination is e.g. an application, a host, a network prefix, a whole Autonomous System (AS) and could also depend on network service if multiple services are supported.) After some time, more and more resources will be pre-allocated by algorithm 1 and fewer resources need to be allocated by algorithm 2 until only sporadic rare peaks in usage are handled by algorithm 2.

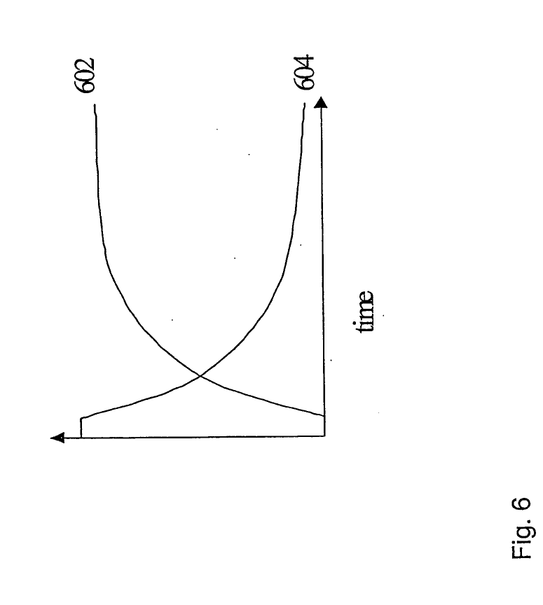

The graph in FIG. 6 shows how more and more of the total amount of requested resources is allocated by algorithm 1 (the curve 602) as the statistics are building up. Without having algorithm 2 (the curve 604), algorithm 1 would have to base its statistics on requested resources and not admitted and used resources and this may be misleading since a client may try and request multiple times for one needed resource. That depends on as described above, that no statistics is available at the beginning, and without having algorithm 2, no statistics will be collected which implies that requested resources would be the only available data. The frequency rate of the resource allocation by algorithm 1 is increased 602 due to that algorithm 2 is also used 604 for building up usage statistics that can be used by algorithm 1.

Big changes in usage patterns or as the previous example of starting up with no statistics at all may involve a large amount of signalling by algorithm 2. In this case a manual adjustment or initialisation of the statistics may be desired to speed up the adaptation of algorithm 1. E.g., algorithm 1 is configured with constructed statistics and it is then possible for algorithm 1 to start allocating resources before true statistics is provided.

Pre-allocating resources between resource managers in advance results in that signalling involving all resource managers is not needed for each client reservation. In, e.g., IP-telephony systems there may be many thousands of requests to a destination during an hour that may be pre-allocated by the resource manager for the whole hour in advance only using one request. Notice that the statistics are preferably based on resource usage per destination. If multiple resource managers are involved, the intermediate resource managers must know the destination of the traffic in order to pre-allocate resources to desired destinations. It is not enough to only adjust the service level agreement between two different resource managers to match the requested resources from the clients, since signalling would still be needed to all involved resource managers for each reservation to be set up. Having pre-allocated resources locally in a specific resource manager, the resource manager in accordance with the present invention can make a local decision to accept or deny new reservation requests without signalling to all involved resource managers. This will increase the rate of admission control and reduce the delay for the client requests.

Algorithm 1 may pre-allocate an hour, a day, an entire week etc. in-advance depending on e.g. the periodicity of the usage history statistics. In the previous example; algorithm 1 would preferably allocate one day in advance and allocate in blocks of one hour for each signalling between resource managers. In another embodiment, the resource manager is signalling once per hour or in yet another embodiment the resource manager allocates all resources at once. Since algorithm 2 allocates resources per resource reservation occasion, several (thousands of) signals may occur for each destination per hour depending on applications and usage patterns, therefore it is desirable that algorithm 1 covers as much of the resources as possible.

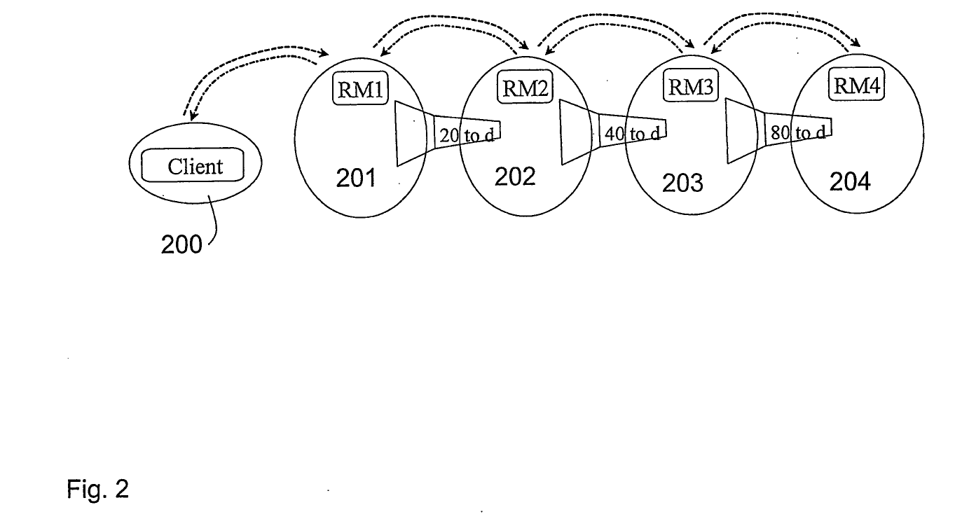

Moreover, since algorithm 2 reserves resources per reservation occasion and does not over-allocate resources the problem with over-allocation per hop discussed earlier and showed in FIG. 2 is avoided.

Algorithm 1 pre-allocates resources per destination. The time interval between each allocation occasion may either be equal for all destinations or differ between the destinations. If there are multiple services or traffic demands for a destination, statistics for individual services may be used to pre-allocate resources which also depend on the service requested.

The statistics stored from previous usage may include the peak value, the average value, the variance etc. and it should be possible to configure algorithm 1 to pre-allocate resources based on these parameters (e.g average+2*sqrt(variance)) The amount to pre-allocate is a trade-off between over-allocation and the amount of signaling that has to be done by algorithm 2. It is also desirable to be able to configure the time in advance, that resources should be allocated and the granularity of the pre-allocation and statistics, e.g one value per parameter for each hour in the example. To reduce the statistic history data stored for each destination, previous values may be weighted into the new values. One example is to use 0.5*previous_value+0.5*the_new_value for each new day and hour. In this way the algorithm will adapt slower to temporary changes in usage than if only one day was looked back. Another example is to use 0.9*previous_value+0.1*the_new_value which will adapt very slowly.

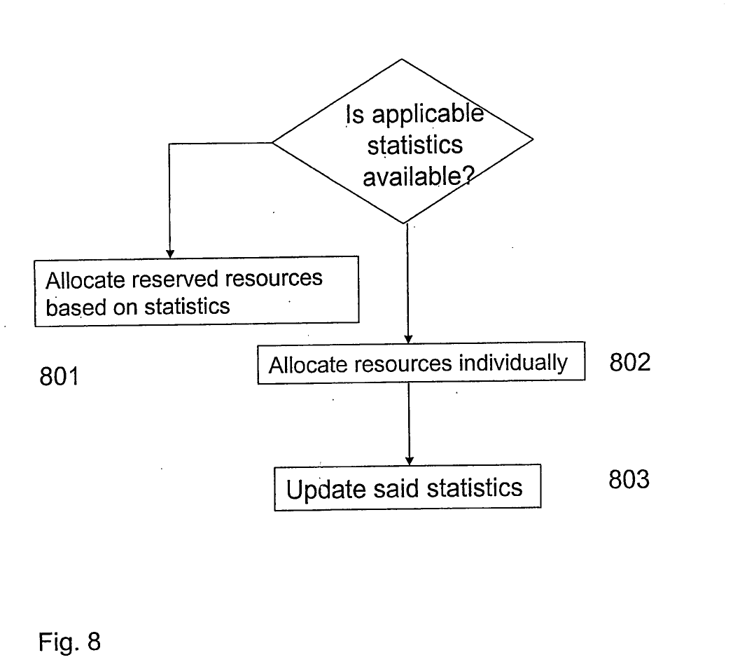

The method for allocating in an IP network in accordance with the present invention is described below in a general mode and illustrated in the flowchart in FIG. 8. The method comprises the steps of:
801. Allocate reserved resources based on usage history statistics when available usage history statistics is applicable to said resource reservation request.
802. Allocate resources individually for said requested resource reservation when applicable usage history statistics is not available.
803. Update said usage history statistics based upon a result of said individually allocated resources.

The method is in accordance with one embodiment of the present invention carried out by a resource manager wherein the resource manager is located within a router or a server within an IP network. The resource manager comprises means 702 for allocating reserved network resources in advance based on usage history statistics 708 when available usage history statistics 708 is applicable to said network resource reservation request, means 704 for allocating network resources individually for said requested network resource reservation when applicable usage history statistics 708 is not available, and means 706 for updating said usage history statistics 708 based upon said individually allocated network resources.

The method may be implemented by means of a computer program product comprising the software code means for performing the steps of the method. The computer program product is run on processing means within a router or/and a server. The computer program is loaded directly or from a computer usable medium.

The present invention is not limited to the above-described preferred embodiments. Various alternatives, modifications and equivalents may be used. Therefore, the above embodiments should not be taken as limiting the scope of the invention, which is defined by the appending claims.

1-18. (canceled)

19. Method for allocating network resources within an IP network, the method is characterised in that it comprises the steps of:
allocating (801) at a first resource manager reserved network resources controlled by at least a second resource manager in advance before a session, that will use said resources, has started based on usage history statistics if available usage history statistics is applicable to said network resource reservation request,
allocating (802) network resources individually for said requested network resource reservation if applicable usage history statistics is not available, and
updating (803) said usage history statistics based upon said individually allocated network resources.

20. Method according to claim 19, wherein the method comprises the further step of:
manual adjusting usage history statistics.

21. Method according to claim 19, wherein said individually allocated network resources is allocated per reservation occasion.

22. Method according to claim 19, wherein said allocated reserved network resources is allocated based on usage history statistics per destination.

23. Method according to claim 22, wherein the time interval between each occasion, which network resources are allocated based on usage history statistics, may either be equal for all destinations or differ between the destinations.

24. Method according to claim 22, wherein said allocation of reserved network resources is further based on statistics for individual services.

25. Method according to claim 19, wherein the usage history statistics comprises any of the parameters a peak value, an average value or a variance.

26. Method according to claim 19, wherein said first and/or second resource manager is implemented within a server or a router in said IP network.

27. A computer program product directly loadable into a server and/or router within an IP network comprising the software code portions for performing the steps of claim 19.

28. A computer program product stored on a computer usable medium, comprising readable program for causing a processing means within a server and/or router within an IP network to control the execution of the steps of claim 19.

29. A first resource manager in an IP-network is characterised in that it comprises means for allocating network resources within the IP network controlled by at least a second resource manager, said first resource manager comprises:
means (702) for allocating reserved network resources in advance before a session, that will use said resources, has started based on usage history statistics (708) when available usage history statistics is applicable to said network resource reservation request,
when applicable usage history statistics (708) is not available,
means (704) for allocating network resources individually for said requested network resource reservation, and
means (706) for updating said usage history statistics (708) based upon said individually allocated network resources.

30. The first resource manager according to claim 29, wherein said resource manager comprises means for manual adjusting usage history statistics.

31. The first resource manager according to claim 29, wherein the resource manager comprises means for allocating said individually allocated network resources per reservation occasion.

32. The first resource manager according to claim 29, wherein the resource manager comprises means for allocating said allocated reserved network resources based on usage history statistics per destination.

33. The first resource manager according to claim 32, wherein the time interval between each occasion, which network resources are allocated based on usage history statistics, may either be equal for all destinations or differ between the destinations.

34. The first resource manager according to claim 32, wherein said means for allocating network resources further comprises means for using statistics for individual services for said allocation network resource reservations.

35. The first resource manager according to claim 29, wherein the usage history statistics comprises any of the parameters a peak value, an average value or a variance.

36. The first resource manager according to claim 29, wherein said resource manager is implemented within a server or a router in said IP network.
